(19) United States
(12) Patent Application Publication
(10) Pub. No.: US 2007/0174387 A1
(43) Pub. Date: Jul. 26, 2007

(54) Methods and apparatus for implementing real-time collective moderation of collaborative environments

(75) Inventors: Frank Lawrence Jania, Chapel Hill, NC (US); Darren Mark Shaw, Hampshire (GB); Brian D. Goodman, Norwalk, CT (US); James Karl Kebinger, Somerville, MA (US)

Correspondence Address: HARRINGTON & SMITH, PC, 4 RESEARCH DRIVE, SHELTON, CT, 06484-6212, US

(73) Assignee: International Business Machines Corporation

(21) Appl. No.: 11/336,439

(22) Filed: Jan. 20, 2006

(51) Int. Cl. G06F 15/16

(52) U.S. Cl. 709/204

(57) ABSTRACT

The present invention concerns methods and apparatus for implementing real-time collective moderation of collaborative user environments by allowing participants in a collaborative environment to collectively control a level of interaction allowed for a target participant in real time. In an embodiment of the invention, collaborators are provided with a user interface having controls for allowing collaborators to indicate a level of interaction that should be allowed for a target participant in the collaborative environment. The controls of the graphical user interface allow a collaborator to indicate that a target participant should be allowed at least one of a greater level of interaction or a lower level of interaction in the collaborative user environment. The level of interaction permitted for a target participant may be governed by changing the number of text characters a target participant can enter per minute; by adjusting the audible volume accorded speech input uttered by a target participant; or by selecting/de-selecting a target participant's webcam as a current view in the graphical user interface.

### TECHNICAL FIELD

The present invention generally concerns moderation systems used in collaborative environments, and more particularly concerns methods and apparatus for implementing moderation of collaborative environments by allowing participants in a collaborative environment to collectively control a level of interaction accorded a target participant in real time.

### BACKGROUND

The advent of the internet has given rise to many heretofore unknown collaborative environments. “Collaborative environment” refers to any network facility supporting interaction among a community of users. Typical examples are electronic community forums (usually associated with a particular topic), newsgroups, blogs, chat rooms, etc. In these settings, collaborators come together and interact through electronic messaging activity, web cams, etc.

A troubling aspect of collaborator interaction in these settings is that it is often contentious, and sometimes even insulting or worse. It is well-known that the level of civility reflected in on-line discourse is often less than that reflected in face-to-face interaction, and this phenomenon extends to on-line collaborative environments. Oftentimes, the lack of civility is exhibited by a person derogatively known as a “troll” who delights in tricking others by getting them to enter into what is thought at first to be a fair-minded dialogue on topics subject to reasonable disagreement, but who then resorts to name-calling and other ad hominem attacks when the argument turns for the worse.

Such situations illustrate the need for a moderator to control activities of those individuals participating in collaborative environments. Several moderator paradigms have developed as a result. The first paradigm is called pre-moderation. In situations where pre-moderation is practiced, before content is posted electronically, it must be submitted for review to a moderator. Only after the electronic content has received approval may it be posted. Another paradigm is called post-moderation. In situations where post-moderation is practiced, electronic content is posted publicly first, and then subjected to moderator review. A further paradigm is called reactive moderation. In situations where reactive moderation is practiced, moderators rely on individuals participating in a collaborative environment to identify situations where content is objectionable. Yet another paradigm is called distributed moderation. In situations where collaborative environments are subject to distributed moderation, moderation responsibilities are in some way assigned to those participating in the collaborative environment.

All four types of moderation are targeted at asynchronous collaboration in which electronic content is published and then read by the community at a later time, but not in real time. There may be a significant time gap between when electronic content is published and when a collaborator reads that article. The article typically has a medium time range exposure. That is, it has an immediate relevance in days or weeks where it has ‘buzz’ with users reading and commenting on it. After that, it has an archive value where comments and reads will be reduced but where it still has a value to the community.

There is currently no community moderation techniques that can be applied to content that has a very short time range exposure, where the community is operating in real time. Examples of communities operating in real time include: multi-party instant messaging, web conferences, live publish/subscribe systems (e.g. IBM community tools). Accordingly, those skilled in the art seek apparatus and methods that can be applied in real time to perform moderation activities in collaborative environments.

### SUMMARY OF THE PREFERRED EMBODIMENTS

The foregoing and other problems are overcome, and other advantages are realized in accordance with the following embodiments of the present invention.

A first embodiment of the present invention comprises a signal-bearing medium tangibly embodying a program of machine-readable instructions executable by a digital processing apparatus of a computer system to perform operations for managing moderator activities in an on-line collaborative environment, wherein the operations comprise: receiving in real time from participants in the on-line collaborative environment a plurality of inputs suggesting a level of participation to be accorded a target participant in the collaborative environment; determining from the plurality of inputs a permitted level of participation to be accorded the target participant in the on-line collaborative environment; and governing the level of participation allowed the target participant in the on-line collaborative environment in accordance with the permitted level of participation.

A second embodiment of the present invention comprises a signal-bearing medium tangibly embodying a program of machine-readable instructions executable by a digital processing apparatus of a computer system to perform operations for implementing a moderator function in a graphical user interface for use in an on-line collaborative environment, the operations comprising: displaying a graphical user interface for use by a moderating participant in the on-line collaborative environment, wherein the graphical user interface has a display area for displaying content submitted by a plurality of participants in the on-line collaborative environment; displaying in the graphical user interface moderation controls for use by the moderating participant in suggesting a level of participation to be accorded a target participant in the collaborative environment; receiving a suggested level of participation to be accorded the target participant in the collaborative environment, wherein the suggested level of participation is entered using the moderation controls; and transmitting over a network in real time the suggested level of participation to be accorded the target participant in the collaborative environment.

A third embodiment of the present invention comprises a signal-bearing medium tangibly embodying a program of machine-readable instructions executable by a digital processing apparatus of a computer system to perform operations for implementing moderation decisions in real time in a graphical user interface for use in a on-line collaborative environment, the operations comprising: displaying a graphical user interface for use by a target participant in the collaborative environment, wherein the graphical user interface has a display area for displaying content submitted by a plurality of participants in the collaborative environment; receiving in real time a permitted level of participation to be accorded the target participant, whereby the permitted level of participation represents a collective determination made by other participants in the on-line collaborative environment, wherein the permitted level of participation regulates an ability of the target participant to interact in the on-line collaborative environment; and applying the permitted level of participation to actions of the target participant.

A fourth embodiment of the present invention comprises an electronic device for performing operations to manage moderation activities in an on-line collaborative environment, wherein the electronic device further comprises: at least one memory to store a computer program; at least one network interface for permitting bi-directional communication over a network; and at least one digital processor coupled to the at least one memory and at least one network interface, wherein operations are performed when the digital processor executes the computer program, the operations comprising: receiving in real time from participants in the on-line collaborative environment a plurality of inputs suggesting a level of participation to be accorded a target participant in the collaborative environment; determining from the plurality of inputs a permitted level of participation to be accorded the target participant in the on-line collaborative environment; and governing the level of participation allowed the target participant in the on-line collaborative environment in accordance with the permitted level of participation.

A fifth embodiment of the present invention comprises an electronic device for use in interacting with an on-line collaborative environment, wherein the electronic device further comprises: at least one memory to store a computer program; at least one network interface for permitting bidirectional communication over a network; and at least one digital processor coupled to the at least one memory and at least one network interface, wherein operations are performed when the digital processor executes the computer program, the operations comprising: displaying a graphical user interface for use by a moderating participant in the on-line collaborative environment, wherein the graphical user interface has a display area for displaying content submitted by a plurality of participants in the on-line collaborative environment; displaying in the graphical user interface moderation controls for use by the moderating participant in suggesting a level of participation to be accorded a target participant in the collaborative environment; receiving a suggested level of participation to be accorded the target participant in the collaborative environment, wherein the suggested level of participation is entered using the moderation controls; and transmitting over a network in real time the suggested level of participation to be accorded the target participant in the collaborative environment.

A sixth embodiment of the present invention comprises a method for implementing moderation decisions in real time in a graphical user interface for use in an on-line collaborative environment, the method comprising: displaying a graphical user interface for use by a target participant in the collaborative environment, wherein the graphical user interface has a display area for displaying content submitted by a plurality of participants in the collaborative environment; receiving in real time a permitted level of participation to be accorded the target participant, whereby the permitted level of participation represents a collective determination made by other participants in the on-line collaborative environment, wherein the permitted level of participation regulates an ability of the target participant to interact in the on-line collaborative environment; and applying the permitted level of participation to actions of the target participant.

In conclusion, the foregoing summary of the embodiments of the present invention is exemplary and non-limiting. For example, one skilled in the art will understand that one or more aspects or steps from one embodiment can be combined with one or more aspects or steps from another embodiment to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a collaborative environment having real-time collective moderating ability made in accordance with the present invention;

FIGS. 2A-B depict a graphical user interface having moderator controls for implementing collective, real-time moderation in a collaborative environment, all in accordance with the present invention;

FIG. 3 is a flow chart depicting a method operating in accordance with the present invention;

FIG. 4 is a flow chart depicting a method operating in accordance with the present invention;

FIG. 5 is a flow chart depicting a method operating in accordance with the present invention; and

FIG. 6 is a flow chart depicting a method operating in accordance with the present invention.

### DETAILED DESCRIPTION OF THE PREFERRED EMBODIMENTS

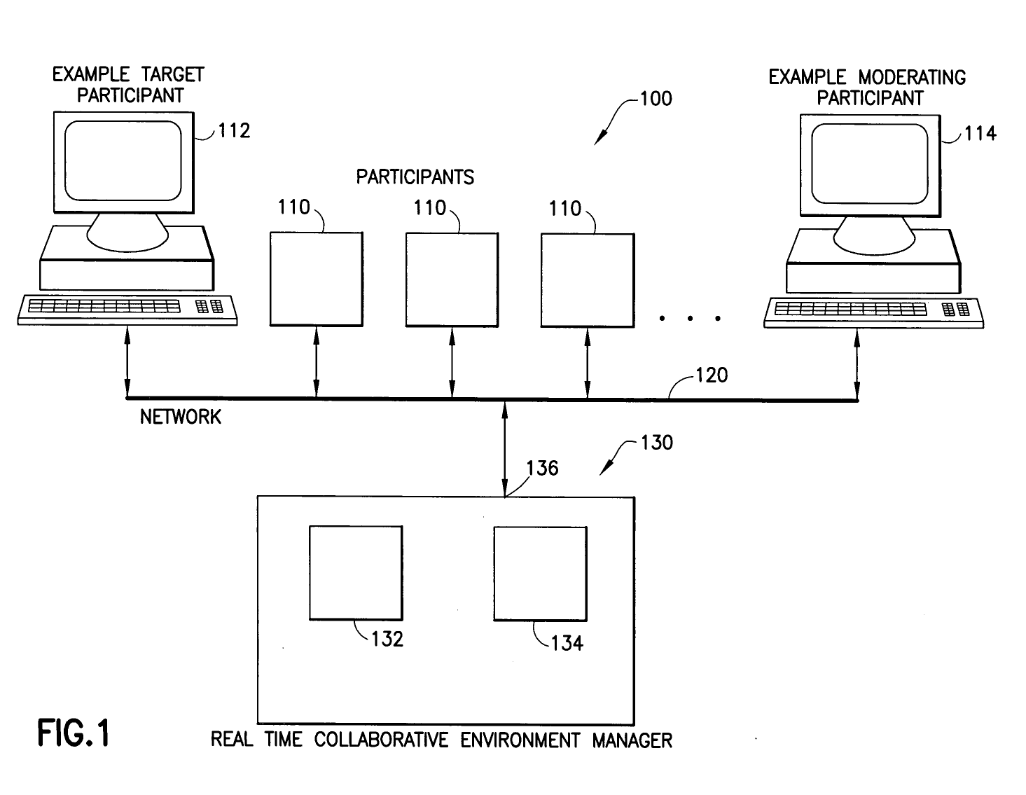

FIG. 1 depicts a system 100 in which the methods and apparatus of the invention may be practiced. In the system 100, computers of a plurality of participants 110 in a collaborative environment are connected to a network 120. The network can be the Internet; a corporate Intranet; a private network, etc. The computers of the participants 110 are in communication with a real-time collaborative environment manager 130. The real-time collaborative environment manager 130 comprises at least a memory 132; a data processor 134; and a network interface 136 for communicating with the network 120. The participants 110 in the collaborative environment are participating in a real-time activity such as, for example, instant messaging; a chat room; a video conference, etc.

While engaging in the real-time activity, the participants 110 will be creating content that will be transmitted over the network 120 to other participants. In conventional systems, there is no way to implement collective moderation of such interaction in real-time. The methods and apparatus of the present invention overcome the limitations of the prior art. In particular, in methods and apparatus of the present invention, participants 110 collectively moderate the collaborative environment in real-time.

This is accomplished as follows. In a typical situation, a target participant 112 is creating content for submission to other participants 110 in the collaborative environment. If a particular participant desires that the activities of target participant 112 be moderated in some way, the participant becomes a moderating participant 114. The moderating participant may like the content created by target participant 112, or may dislike it. In either case, the moderating participant 114 accesses moderation functionality associated with the software providing the collaborative environment.

Through the moderation functionality, the moderating participant 114 suggests a level of participation to be accorded the target participant 112. This suggested level of participation is submitted over the network 120 to the real-time collaborative environment manager 130. The real-time collaborative environment manager 130 receives the suggested level of participation from moderating participant 114 and from other participants 110 seeking to regulate the activities of target participant 112. The real-time collaborative environment manager determines a permitted level of participation to be accorded the target participant in dependence on the level of participation suggested by moderating participant 114 and other participants 110 in the collaborative environment.

The permitted level of participation may function in many ways. For example, it may prevent the target participant from submitting additional content to other participants 110 in the collaborative environment. This may be done for a period of time, or the target participant may be permanently barred from the collaborative environment. In other embodiments of the invention, the permitted level of participation accorded the target participant may restrict the target participant's ability to receive and play content generated by other participants. In further embodiments of the invention, the permitted level of participation may function as a filter, modifying content received from the target participant. In still further embodiments of the invention, the permitted level of participation may selectively control access to functionality of the collaborative environment. For example, the target participant may be prevented from submitting video content to other participants, but may be allowed to send text messages.

In one embodiment of the invention, the permitted level of participation may be implemented as a volume model. The volume associated with each participant impacts the amount of influence each participant is permitted during an on-line collaboration by adjusting the level of visibility permitted content generated by participants. In such an embodiment a pre-determined number or possibly all participants can suggest volume levels to be accorded other participants. All suggestions can be treated equally, or suggestions can be weighted in accordance with the level of visibility factor accorded each participant.

Typically, the collaborative environment is generated by a software program that creates a graphical user interface through which users interact. Moderation controls used to suggest a volume level to be accorded a participant may be incorporated in the graphical user interface of the collaborative environment. In one implementation, the volume level suggestion is accomplished using a single-click action to minimize system overhead in taking such action. A participant can suggest three actions to be applied to a target participant:
shock—suggests that the volume accorded a target participant be reduced;
cheer—suggests that the volume accorded a target participant be increased; and
spotlight—suggests that a target participant's content be emphasized in some manner.

If suggestions for a volume level adjustment are received from enough of the participants, the real-time collaborative environment manager 130 determines the appropriate volume adjustment based on suggestions and applies them immediately to content generated by the target participant. A particular advantage of the invention is that the collective moderation occurs in real time and, as a result, has an immediate effect.

The “cheer and shock” volume level adjustment may be implemented as follows. The real-time collaborative environment manager (which may be implemented as a stand-alone server separate from the participant's machines, or may be implemented on a particular participant's computer) contains a volume “setting” for each participant in the collaborative environment. The volume “setting” would typically be different for each collaborative environment in which a particular target participant participates. In alternative embodiments, the volume setting for each collaborative environment may be combined in various ways, possibly with volume settings associated with particular collaborative communities being given greater weight than volume levels associated with other collaborative communities. Such an average volume level may be assigned as the default initial setting when target participants enter a new online collaborative community. This may be implemented in an XML model as follows:

```
<?xml version=”1.0” encoding=”utf-8”?>
  <volumemodel userid=”shawdm.uk.ibm.com” individualvolume=”46”>
    <community name=”Blackburn Rovers FC” volume=”74”/>
    <community name=”Hursley ETS Group” volume=”23”/>
    <community name=”Britney Spears Fanclub” volume=”59”/>
  </volumemodel>
</xml>
```

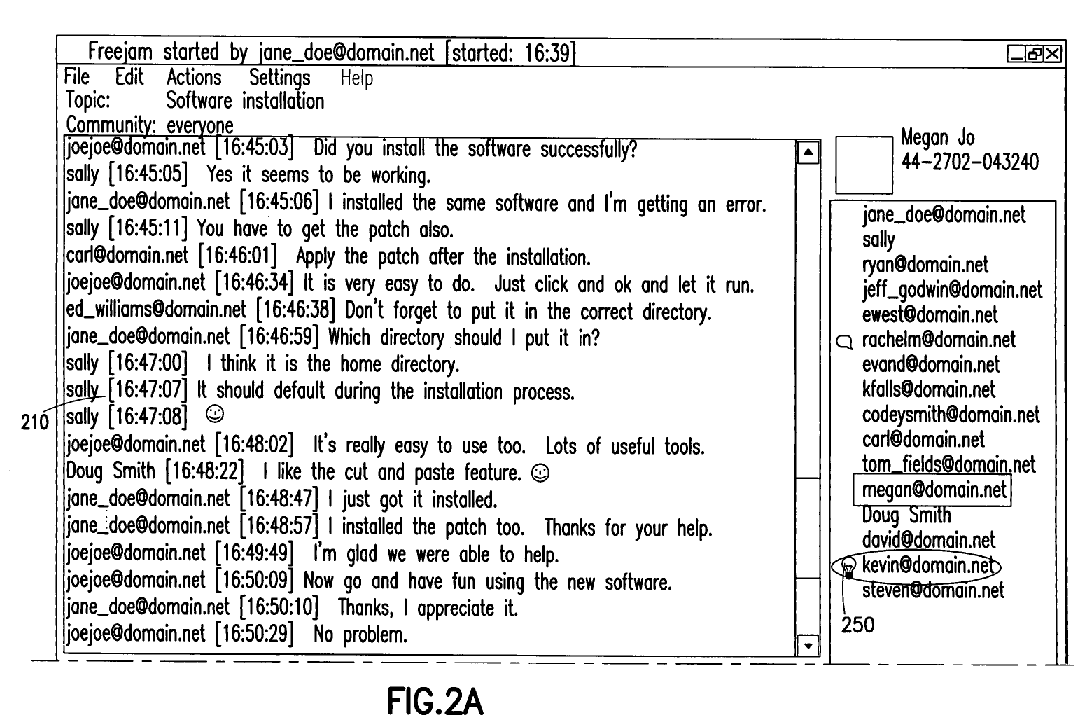

An example graphical user interface 200 associated with a collaborative environment is depicted in FIGS. 2A-B. In this particular example, the graphical user interface is associated with an instant messaging application. Content received from the participants is displayed in area 210. Messages are drafted in area 220 before the messages are submitted. Participant area 230 identifies participants in the current instant messaging session. Icon 242 is the “cheer” control and icon 244 is the “shock” control. Using these controls, a moderating participant suggests whether the volume accorded a target participant is to be increased or reduced.

In various embodiments the “cheer” control 242 and “shock” control 244 can be used at any time to suggest a volume level to be accorded a particular target participant, or alternatively, it can be used only when a target participant has the focus of the collaborative environment. On selecting either the “cheer” 242 or “shock” 244 icon a moderation suggestion message is sent from the moderating participant's 114 computer to the real-time collaborative environment manager 130. The moderation suggestion message comprises at least:
a user ID of the moderating participant;
a user ID of the target participant; and
the type of feedback suggested—“cheer” or “shock”.
   When the real-time collaboration manager receives the moderation suggestion message it assigns a time stamp to the message, and the message becomes “active”, meaning it will be considered when making moderation decisions concerning a particular target participant. After a pre-determined time (which may be selectable by an administrator of the collaborative environment) the message will expire and be discarded. This means the message will no longer be consulted to determine a volume level to be accorded a target participant.

The real-time collaborative environment manager 130 aggregates all active messages about a particular target participant in order to determine the volume level to be accorded that target participant. There are various ways the moderation suggestions may be combined; for example, each suggestion may be given equal weight; or each suggestion may be weighted according to the status of a moderating participant making the suggestion. The status may be derived from the volume level accorded the moderating participant making the suggestion, or it may be set independently from the volume level. In one method, a “cheer” message would cancel a “shock” message for no net effect. Alternatively, in a ratio which may be set by an administrator, one “cheer” message may cancel a pre-determined number of “shock” messages, or vice-versa. In one embodiment, a target participant would be assigned a nominal volume level of fifty. After a period of time, a target participant with a volume level above fifty would have generated a majority of “cheer” messages and a target participant with a volume level below fifty would have generated a majority of “shock” messages.

The volume level determined for a target participant is used to control the level of participation accorded the target participant in the collaborative environment. Depending on the type of collaborative environment, the adjustment in volume level can have various effects. In addition, in embodiments of the invention the participation level suggestion messages may have limited time duration, after which they no longer affect a participant's volume level. For example, as the moderation suggestion messages expire, a target participant's volume level changes in a gradual return to a nominal level of fifty. For example, if a participant has received a number of “cheer” messages that have pushed her volume level above fifty, as those “cheer” messages expire, her volume level will return to a nominal level of fifty. The same will happen for participants whose volume level has been reduced below fifty by a predominance of “shock” messages. As the “shock” messages expire, the participants' volume level will increase back to fifty. In embodiments where only a currently participating participant can have her activities moderated, a target participant can ensure that her volume level returns to the nominal level of fifty by simply refraining from participating. Other methods can be instituted within the context of the present invention to limit the time duration of participation level suggestion messages.

Another real-time moderation action provided by the present invention is called “spotlighting”. A target participant who has been accorded the “spotlight” by the moderating participants is granted a greater degree of control over the collaboration environment then other participants—including possibly total control over the collaboration environment. The level of control accorded a participant having the “spotlight” may be decided by an administrator of the collaborative environment. After a period of time, the “spotlight” status accorded a target participant will lapse and the target participant will return to a nominal level of control over the collaborative environment.

In embodiments of the invention, a target participant need not be currently participating to be accorded the “spotlight”. A moderating participant suggests that a target participant be accorded spotlight status in the following manner. The moderating participant selects a desired target participant in the participant area 230. While the desired target participant is highlighted in conventional manner by, for example, a shaded region, the moderating participant selects the spotlight option 246 in the graphical user interface. On selecting the spotlight option by, for example, clicking the appropriate icon, a message is sent from the computer of the moderating participant to the real-time collaborative environment manager 130. The message comprises:
an indication that it is a spotlight message;
the user ID of the moderating participant; and
the user ID of the target participant suggested to be accorded the spotlight.
   On receiving the message the server assigns a timestamp to the message and the message becomes active. After a period of time (configurable by an administrator) the message will expire and be discarded.

The server aggregates all active spotlight messages in order to determine which user should be accorded spotlight status, if any. Spotlight status will be accorded a particular participant when a threshold level of spotlight messages is received for that particular participant. The threshold level of messages may be selected by an administrator of the real-time collaborative environment. In a situation where multiple participants exceed the threshold, spotlight status will be accorded to the participant with the highest number of spotlight-supporting messages, or to a participant exceeding the threshold on a random basis.

In variants of embodiments of the invention implementing the spotlight function, a participant who has been accorded the spotlight will have their spotlight-supporting messages cancelled, and the count of spotlight-supporting messages reset to zero. This will allow a participant having the next-highest level of spotlight-supporting messages to assume spotlight status, if that participant has a number of active spotlight-supporting messages exceeding the threshold.

The fact that a participant has been accorded the spotlight status can be indicated in the graphical user interface 200 in various ways (such as, for example, by placing a light bulb 250 next to the participant's identifier).

In embodiments of the invention, a weighting function may be implemented to determine how much relative impact a particular moderating participant's suggestions should have. As described previously, shock and cheer messages may have an administrator-defined ratio. For example, a 5:1 ratio may be defined so that five shock messages are counterbalanced by a single cheer message.

In other embodiments a different weighting criterion can be applied. In these embodiments each moderating participant's shock and cheer messages will be accorded different weightings, based on the volume level they themselves have been assigned. For example, a moderating participant with a volume level of fifty and therefore neutral in terms of feedback would be accorded a weighting of 1. A moderating participant with a volume level of 100 (fully positive responses) will have a weighting of ten, meaning her suggestions will be accorded ten times as much weight as the moderating participant having a neutral volume level. A user with a volume level of zero will have a weighting of 0.1. All messages received are multiplied by the moderating participant's weighting factor before being aggregated. In such embodiments, those participants who are regarded as making a positive contribution to the collaboration will have a greater say in deciding what level of participation will be accorded each user.

The volume level accorded a user may be implemented in many ways depending on the nature of the collaborative environment. A positive contribution by a target participant (as seen by the community participating in the collaborative environment) should result in the target participant being accorded the opportunity to make a more widely visible contribution. A collective determination that a target participant is making a negative contribution means that the target participant's ability to participate should be restricted. Techniques available for changing a target participant's ability to participate in both positive and negative ways include, but are not limited to:
changing the amount of text characters a target participant can enter per minute;
adjusting the audible volume accorded speech input received from a target participant;
setting a target participant's web cam as the current view;
preventing a target participant's web cam from becoming the current view;
increasing the font size of a target participant's text input;
decreasing the font size of a target participant's text input;
fading a target participant's text input
blocking a target participant's input;
introducing a pro-active requirement on users to request input from a low-volume-level user—a visual indication could be made that a user having a low volume level is trying to make an input to the discussion—the input could be viewed after entry of a click-through.

Different input restriction filters may be selected to correspond to specific volume levels. A target participant with only a slightly reduced volume level may trigger a low level filter, such as a restriction on the web cam becoming the current view. A target participant with a very low volume level may have a harsher restriction imposed such as a complete input block.

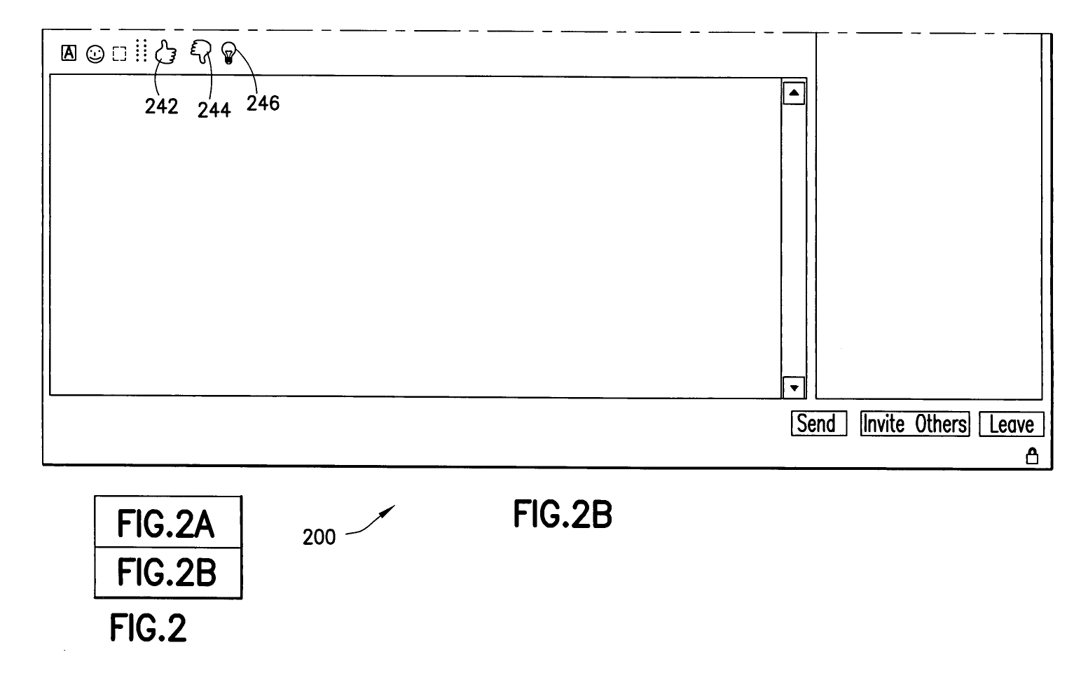

The foregoing methods are summarized in FIGS. 3-6. FIG. 3 depicts steps of a method that would be performed by a computer program executed by digital processor 134 of real-time collaborative environment manager 130. In the method, the real-time collaborative environment manager at step 310 would receive in real time from moderating participants a plurality of inputs suggesting a level of participation (such as, for example, a suggested “volume level”) to be granted to a target participant in the collaborative environment. Then, at step 320, the real-time collaborative environment manager would determine from the plurality of inputs a permitted level of participation (such as, for example, an actual “volume level”) to be granted the target participant. In determining the level of participation, a weighting function can be applied depending on the identity of the moderating participant. Next, at step 330 the real-time collaborative environment manager 130 governs the level of participation allowed the target participant in accordance with the permitted level of participation. In various situations, this step would entail various content filtering operations such as blocking content received from the target participant; changing the audible volume level accorded speech input received from the target participant; changing the font size of text received from the target participant, etc.

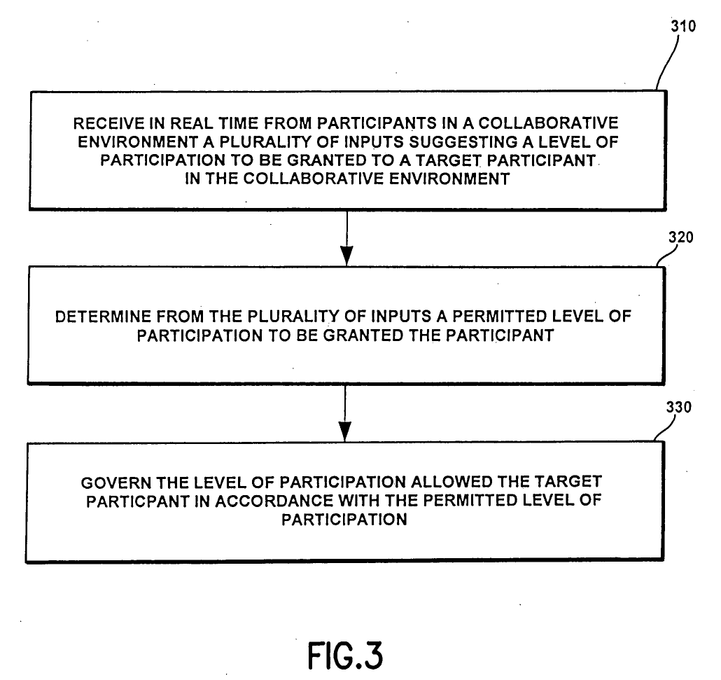

FIG. 4 depicts steps of a method that would be performed on a moderating participant's 114 computer like that depicted in FIG. 1. When executing a computer program which implements the collaborative environment, a digital processor of the moderating participant's computer at step 410 would display a graphical user interface for use by the moderating participant. The graphical user interface typically would be the means by which the moderating participant participates in the collaborative environment, and may in a text messaging scenario have the format depicted in FIGS. 2A-B. At step 420, moderation controls would be displayed in the graphical user interface for use by the moderating participant in suggesting a level of participation to be granted a target participant in the collaborative environment. The moderation controls can comprise the “cheer” 242 and “shock” 244 controls depicted in FIG. 2B or they may comprise other controls such as, for example, rotary dials, percentage scales, sliders, etc. Then, at step 430 the moderating participant's computer would receive a suggested level of participation to be accorded a target participant, entered by the moderating participant using the moderation controls. Then, at step 440, the moderating participant's 114 computer would transmit a message to the real-time collaborative environment manager 130 containing the level of participation suggested by the moderating participant.

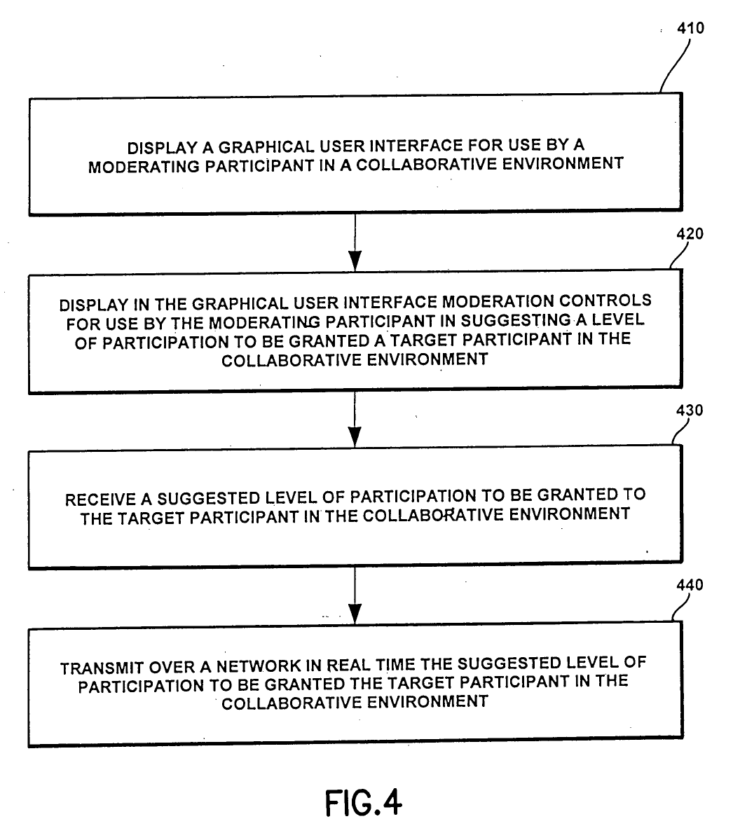

FIG. 5 depicts steps of a method typically practiced by the computer of any participant 110 in the collaborative environment. After content generated by the target participant has been modified in accordance with the level of participation granted to the target participant by the real-time collaborative environment manager 130, a participant's 110 computer receives in real time at step 510 the modified content. Then at step 520, the content is played back on the participant's 110 computer in the modified form.

In various alternate embodiments, the modification of the content generated by the target participant in accordance with the level of participation accorded the target participant can be performed by the real-time collaborative environment manager 130; by the target participant's 112 computer; or by each of the participants' 110 computers. In situations when the modification is not performed by the real-time collaborative environment manager 130, it would be performed in dependence on control signals generated by the real-time collaborative environment manager 130.

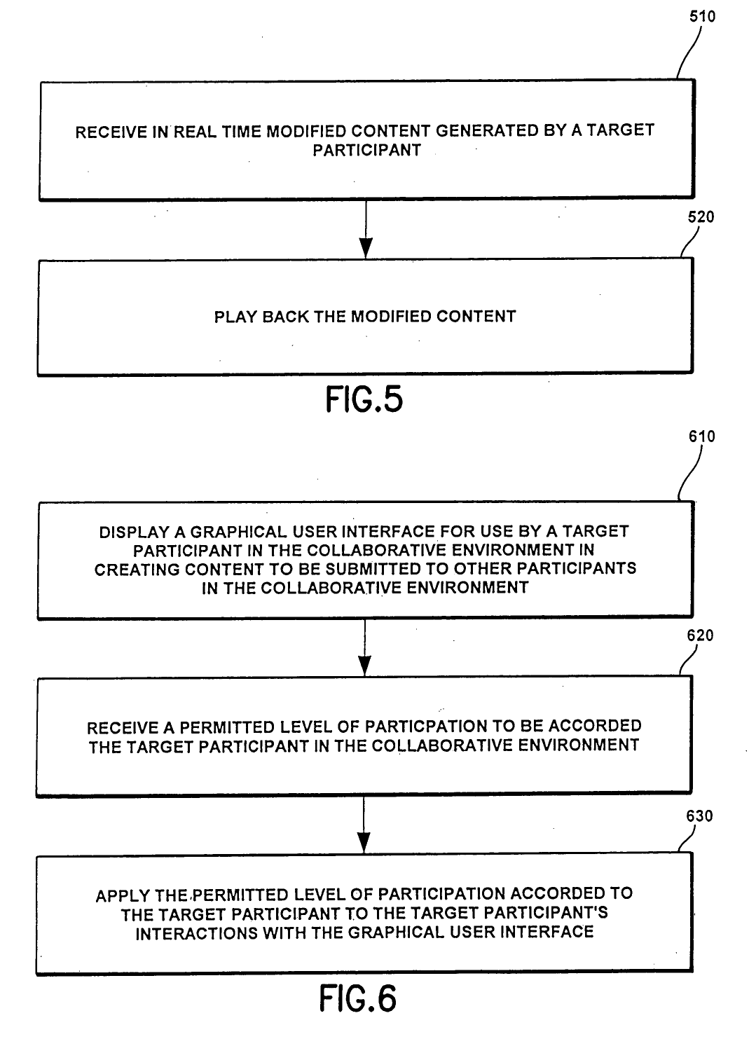

FIG. 6 depicts steps of a method practiced by a target participant's 112 computer. In various embodiments of the invention, increased or decreased levels of participation accorded to a target participant may have an impact on a target participant's ability to interact with the graphical user interface providing the collaborative environment. For example, controls may be made available to a target participant accorded the spotlight which are not normally available to regular participants in the collaborative environment. Alternatively, a target participant may be blocked from entering any content at all.

At step 610, a digital processor of target participant's computer would execute a computer program component that displays a graphical user interface for use by a target participant in the collaborative environment in creating content to be submitted to other participants in the collaborative environment. Then, at step 620, the target participant's computer receives over the network a permitted level of participation to the accorded the target participant in the collaborative environment. Then, at step 630, the digital processor of target participant's 112 computer performs operations to apply the permitted level of participation accorded the target participant to the target participant's interactions with the graphical user interface.

One skilled in the art will understand that the methods depicted in FIGS. 3-6 can be embodied in a physical memory medium readable by digital processing apparatus associated with a computer system in other embodiments made in accordance with the invention. In these embodiments of the invention, computer program instructions of a computer program fixed in the physical memory medium are capable of performing operations corresponding to the steps of the method when executed by a digital processing apparatus. Physical machine-readable memory media include, but are not limited to, hard drives, CD- or DVD-ROM, flash memory storage devices, or RAM memory of a computer system.

Thus it is seen that the foregoing description has provided by way of exemplary and non-limiting examples a full and informative description of the best methods and apparatus presently contemplated by the inventor for implementing real-time collective moderation of collaborative environments. One skilled in the art will appreciate that the various embodiments described herein can be practiced individually; in combination with one or more other embodiments described herein; or in combination with collaborative environments differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

We claim:

1. A signal-bearing medium tangibly embodying a program of machine-readable instructions executable by a digital processing apparatus of a computer system to perform operations for managing moderator activities in an on-line collaborative environment, wherein the operations comprise:
receiving in real time from participants in the on-line collaborative environment a plurality of inputs each suggesting a level of participation to be accorded a target participant in the collaborative environment;
determining from the plurality of inputs a permitted level of participation to be accorded the target participant in the on-line collaborative environment; and
governing the level of participation allowed the target participant in the on-line collaborative environment in accordance with the permitted level of participation.

2. The signal-bearing medium of claim 1 wherein an input received from a particular participant recommends that the level of participation accorded the target participant be increased.

3. The signal-bearing medium of claim 1 wherein an input received from a particular participant recommends that the level of participation accorded the target participant be reduced.

4. The signal-bearing medium of claim 1 wherein governing the level of participation accorded the target participant is accomplished using a participation filter, wherein the operations further comprise:
receiving content from the target participant;
filtering the content received from the target participant in accordance with the participation filter, thereby creating filtered content; and
providing the filtered content to other participants in the on-line collaborative environment.

5. The signal-bearing medium of claim 4 wherein the content received from the target participant comprises text information, and the participation filter comprises at least one filter operation selected from the group of: applying a large font to the text information; applying a small font to the text information; displaying the text in boldface; applying a word limit to the text information; and blocking the text information.

6. The signal-bearing medium of claim 4 whereby the content received from the target participant comprises audio information and wherein the participation filter comprises at least one filter operation selected from the group of: increasing the volume of the audio information; decreasing the volume of the audio information; and blocking the audio information.

7. The signal-bearing medium of claim 4 whereby the content received from the target participant comprises video information and wherein the participation filter comprises at least one filter operation selected from the group of: granting current view status to the video information; enlarging the display area devoted to the video information received from the target participant; decreasing the display area devoted to the video information received from the target participant; presenting the video information received from the target participant in color; presenting the video information received from the target participant in black and white; fading the video information received from the target participant; and blocking the video information.

8. The signal-bearing medium of claim 1 wherein inputs received from participants recommend that the target participant be accorded spotlight status.

9. The signal-bearing medium of claim 8 whereby in order for the target participant to be accorded spotlight status at least a threshold number of inputs suggesting that the target participant be accorded spotlight status must be received, wherein determining from the plurality of inputs a permitted level of participation further comprises determining whether at least the threshold number of inputs have been received.

10. The signal-bearing medium of claim 9 wherein it is determined that at least a threshold level of inputs suggesting that the target participant be accorded spotlight status have been received, whereby governing the level of participation further comprises according the target participant spotlight status.

11. The signal-bearing medium of claim 10 wherein having spotlight status accords the target participant a greater degree of control over the on-line collaborative environment.

12. The signal-bearing medium of claim 11 wherein the exact degree of control over the on-line collaborative environment associated with spotlight status is selected by an administrator of the on-line collaborative environment.

13. The signal-bearing medium of claim 10 wherein the spotlight status accorded the target participant lapses after a pre-determined time.

14. The signal-bearing medium of claim 13 wherein after the spotlight status accorded the target participant has lapsed, additional operations are performed, the additional operations comprising:
canceling inputs suggesting that the target participant be accorded spotlight status received before the target participant was accorded spotlight status; and
resetting to zero a count tracking the number of inputs received suggesting that the target participant be accorded spotlight status.

15. The signal-bearing medium of claim 1 wherein the operations further comprise:
instituting an active time period for inputs received suggesting a level of participation to be accorded a target participant, wherein after the active time period has passed since a particular input was received, the particular input is cancelled as being stale and no longer considered when determining the level or participation to be accorded the target participant;
applying a timestamp to each input received;
prior to determining from the plurality of inputs a permitted level of participation to be accorded the target participant, for each input determining whether the input has become stale due to the passage of time; and
eliminating stale inputs from consideration when determining a permitted level of participation to be accorded the target participant.

16. An electronic device for use in interacting with an on-line collaborative environment, wherein the electronic device further comprises:
at least one memory to store a computer program;
at least one network interface for permitting bi-directional communication over a network; and
at least one digital processor coupled to the at least one memory and at least one network interface, wherein operations are performed when the digital processor executes the computer program, the operations comprising:
displaying a graphical user interface for use by a moderating participant in the on-line collaborative environment, wherein the graphical user interface has a display area for displaying content submitted by a plurality of participants in the on-line collaborative environment;
displaying in the graphical user interface moderation controls for use by the moderating participant in suggesting a level of participation to be accorded a target participant in the collaborative environment;
receiving a suggested level of participation to be accorded the target participant in the collaborative environment, wherein the suggested level of participation is entered using the moderation controls; and
transmitting over a network in real time the suggested level of participation to be accorded the target participant in the collaborative environment.

17. The electronic device of claim 16 wherein the operations further comprise:
receiving content generated by the target participant that has been filtered in accordance with a participation filter determined in dependence on suggested levels of participation for the target participant submitted by other participants in the on-line collaborative environment; and
playing back the content to the moderating participant.

18. A method for implementing moderation decisions in real time in a graphical user interface for use in an on-line collaborative environment, the method comprising:
displaying a graphical user interface for use by a target participant in the collaborative environment, wherein the graphical user interface has a display area for displaying content submitted by a plurality of participants in the collaborative environment;
receiving in real time a permitted level of participation to be accorded the target participant, whereby the permitted level of participation represents a collective determination made by other participants in the on-line collaborative environment, wherein the permitted level of participation regulates an ability of the target participant to interact in the on-line collaborative environment; and
applying the permitted level of participation to actions of the target participant.

19. The method of claim 18 wherein the graphical user interface implements varying degrees of functionality associated with the on-line collaborative environment, whereby the permitted level of participation determines what functionality associated with the on-line collaborative environment is accessible to the target participant.

20. The method of claim 18 wherein the permitted level of participation is implemented as a participation filter and whereby applying the permitted level of participation to actions of the target participant further comprises:
applying the participation filter to content created by the target participant as the target participant generates content, thereby permitting the target participant to observe effects of the participation filter on content created by the target participant.
